(19) United States
(12) Patent Application Publication
(10) Pub. No.: US 2020/0387157 A1
(43) Pub. Date: Dec. 10, 2020

(54) SYSTEM AND METHODS TO ENABLE UNATTENDED WAYFINDING

(71) Applicant: International Business Machines Corporation, Armonk, NY (US)

(72) Inventors: John Handy BOSMA, Leander, TX (US); Sri Kiran Panchavati GANESH, Austin, TX (US); Charles Paul HOFER, Austin, TX (US); Kala NENKOVA, Cedar Park, TX (US); Julie A. SCHUNEMAN, Jacksonville, FL (US)

(21) Appl. No.: 16/435,664

(22) Filed: Jun. 10, 2019

(51) Int. Cl. G05D 1/00; G05D 1/02; G01C 21/34

(52) U.S. Cl. CPC G05D 1/0088; G05D 1/0214; G01C 21/34; G05D 1/0231; G05D 1/0276

(57) ABSTRACT

A system (and method and computer product) to provide a service using an autonomous agent and wayfinding instructions includes a processor and a memory device accessible to the processor. The memory device stores a set of machine-readable instructions to permit the processor to execute a method for providing a service using agents capable of autonomously navigating unattended within a service area, as guided along a predetermined path based on receiving wayfinding instructions. The processor includes a communication port to permit a communication during assignments with one or more communication devices on a wayfinding device carried by or attached to an agent selected for implementing an assignment. The method includes receiving a request for the service from a user at a first location for the service to start as originating at the first location and to end at a destination at a second location; mapping a routing between a current location of the agent selected to implement the service request as an assignment to the first location and a mapping between the first location and the destination at the second location; and dispatching the agent selected for the assignment from the agent's current location to the first location, to meet up the user making the request for service, the agent being guided to the first location using wayfinding guidance instructions received via a receiver on or attached to the wayfinding device. The agent has a capability to respond to wayfinding guidance instructions received via the wayfinding device.

### BACKGROUND

The present invention relates generally to a method and system to provide on-call/on-demand services using autonomous agents. More specifically, a wayfinding system uses communication provided via a wayfinding device, mounted on or attached to an agent assigned to implement a service request, to enable unattended wayfinding guidance of the agent during the assignment, based on tracking the agent's current location and providing wayfinding instructions from a remotely-located computer, the system also having the capability to detect a pattern predetermined as indicating that the agent is stalled on the originally-intended path so that a new path with updated wayfinding instructions has to be computed to complete the assignment.

### SUMMARY

In accordance with an exemplary embodiment, the present invention discloses a system (and method and computer product), including a processor and a memory device accessible to the processor, the memory device storing a set of machine-readable instructions to permit the processor to execute a method for providing a service using agents capable of autonomously navigating unattended within a service area, as guided along a predetermined path based on receiving wayfinding instructions. The processor comprises a communication port to permit a communication during assignments with one or more communication devices on a wayfinding device carried by or attached to an agent selected for implementing an assignment. The method comprises: receiving a request for the service from a user at a first location for the service to start as originating at the first location and to end at a destination at a second location; mapping a routing between a current location of the agent selected to implement the service request as an assignment to the first location and a mapping between the first location and the destination at the second location; and dispatching the agent selected for the assignment from the agent's current location to the first location, to meet up the user making the request for service, the agent being guided to the first location using wayfinding guidance instructions received via a receiver on or attached to the wayfinding device. The agent has a capability to respond to wayfinding guidance instructions received via the wayfinding device.

In accordance with another exemplary embodiment, also described herein is a method to provide a service using agents capable of autonomously navigating within a service area as guided based on receiving wayfinding instructions, the method comprising: receiving a request for the service from a user at a first location for the service to start as originating at the first location and to end at a destination at a second location; mapping a routing between a current location of an agent selected to implement the service request to the first location and a mapping between the first location and the destination at the second location; and dispatching the selected agent from its current location to the first location to meet up with the user making the request for service, the selected agent being guided to the first location using wayfinding guidance instructions received via a receiver on a wayfinding device mounted on or attached to the selected agent. The selected agent has a capability to respond to wayfinding guidance instructions received via the wayfinding device.

In accordance with another exemplary embodiment, also described herein is a method to provide a service using agents capable of autonomously navigating within a service area as guided based on receiving wayfinding instructions, the method comprising: receiving a request for the service from a user; determining a routing to be followed by an agent to be dispatched to implement the received service request; and dispatching the agent to implement the received service request, the dispatched agent being guided along the determined routing using wayfinding guidance instructions received via a receiver on a wayfinding device mounted on or attached to the dispatched agent. The dispatched agent has a capability to respond to wayfinding guidance instructions received via the wayfinding device, and the wayfinding device carried by or attached to the dispatched agent further comprises a sensor that detects when the dispatched agent has encountered an impediment to the routing mapped out for the assignment, so that a new routing can be determined for guiding the dispatched agent to complete implementing the received service request.

### BRIEF DESCRIPTION OF THE DRAWINGS

FIG. 1 shows a block diagram 100 of components of an exemplary embodiment of the invention;

FIG. 2 shows a flowchart 200 of an exemplary embodiment of the present invention;

FIG. 3 shows a flowchart 300 of path recalculation when a path impediment is detected;

FIG. 4 shows a cloud computing environment according to an embodiment of the present invention; and

FIG. 5 depicts abstraction model layers according to an embodiment of the invention.

### DETAILED DESCRIPTION

The embodiments described herein solve problems involving an unattended autonomous agent dispatched to implement an assignment using wayfinding instructions issued from a remotely-located computer, such as a server on the Internet or a computer at a home base station of an on-call or on-demand service provider. In the context of the present invention, an agent or unattended agent or autonomous agent is intended to refer to something that can operate autonomously (e.g., without a human operator) and that can be used to perform a specific service type such as, for example, transporting an object or person from a pick up location and transporting them to a destination location.

Non-limiting examples of types of agents relevant to the present invention include such devices as, for example, a flying or otherwise mobile drone or a self-driving vehicle or a robot, all of which can be outfitted to be capable of maneuvering autonomously without having a human operator controlling or supervising its operation. In the present invention, these autonomous machines are also configured to be capable of responding to wayfinding signals transmitted from a remotely-located computer, which wayfinding signals thereby provide guidance of the autonomous machines along a predetermined path within an area served by a service provider implementing methods of the present invention. Such autonomous agents can be dispatched to implement a service assignment such as, for example, to make a delivery of a product to a consumer, or a self-driving vehicle dispatched to pick up a consumer or item and proceed to a predetermined destination with the item or consumer on board.

In some service types, an autonomous agent could even be a service animal, for example, a dog specially-trained to respond to wayfinding instructions received via a wayfinding device on a harness or collar. In these embodiments, the dog would also be trained to navigate autonomously in an environment expected to be a service area around a home base station from which the agents are dispatched on an assignment.

The present invention even includes also embodiments in which a human riding in, for example, an autonomous self-driving vehicle receives wayfinding instructions via a speaker in the vehicle which the rider would then provide as inputs into interface controls of the self-driving vehicle, or the self-driving vehicle could simply receive the wayfinding instructions as an input into its autonomous guidance control system.

Similarly, the autonomous agents could also be the consumer/user themselves as, for example, renting a vehicle such as a rental car or a rental electric scooter or electric skateboard and receiving wayfinding instructions on how to get to a specific location. It is noted that, these latter exemplary embodiments, the consumer/user is presumed to be corresponding to the autonomous agent capable of navigating unattended in the service area.

Thus, a distinguishing characteristic of the present invention is that an autonomous agent receives wayfinding instructions during an assignment as transmitted from a remote computer located, for example, at the home base station of the on-call service provider or as a server accessible via the Internet. These wayfinding instructions are issued to the agent based on tracking the agent's current location, thereby the wayfinding instructions provide ongoing guidance to the agent that serve to define a path predetermined by the remote computer for the agent to follow in implementing the assignment.

In the context of the present invention, a wayfinding instruction is intended to refer to directional instructions received by an agent from the remotely-located computer and, depending upon the type of agent, could be as simple as “go”, “stop”, “right”, “left”, “straight ahead”, “reverse”, etc. In the case of autonomous vehicles that can respond to more nuanced instructions, such as a flying drone, the wayfinding instruction might define a precise amount of correction right or left, such as meaning “bear left 5 degrees”, etc., as well as responding to wayfinding guidance related to altitude. In other autonomous vehicles such as a self-driving automobile or truck, the instructions could be coarser, to include instructions such as meaning “bear left at the upcoming split in the road”, in view that the self-driving vehicle will autonomously follow the roadway.

In the case of a trained dog serving as an autonomous agent, the service area would typically be an urban environment and the intended path for an assignment would typically be a combination of segments of sidewalks and walkways, and the wayfinding instructions could be similar to the simple instructions listed above. In these embodiments, the dog would also be trained to navigate autonomously in the intended urban environment.

Another distinguishing characteristic of many exemplary embodiments of the present invention is that the agent carries a wayfinding device that not only transmits the agent's current location but also includes one or more sensors, such as an accelerometer, to detect a pattern indicating that the agent has encountered an impediment to continuing on the intended path. The wayfinding device can then transmit a signal back to the home base station that is interpreted that the intended path is impeded in some manner so that new wayfinding instructions defining a modified path are needed in order to continue carrying out the assignment.

For example, in the present invention, conditions or events such as weather conditions, natural disasters such as flooding or a fire, traffic congestion, or other path obstacle such as encountering an accident or traffic due to an accident along the intended path for the assignment, might require that the home base station provide updated wayfinding instructions that define a new path to complete the assignment and to send updated wayfinding instructions to proceed with the assignment.

In some exemplary embodiments, the remote computer providing the wayfinding instructions to the autonomous agent will be able to infer an impediment by reason that it receives data for the current location of the agent, so that an impediment can be inferred if the agent takes more than a predetermined time period to move or to complete a current route segment.

Thus, the concept of guiding an autonomous agent using wayfinding instructions issued from a remote location and based on knowing current position of the agent differs from the conventional method of guiding an autonomous agent using a path preprogrammed into a memory device of a computer controlling an autonomous agent. Wayfinding guidance permits an originally-defined desired path to be modified without having to reprogram a path previously stored in a memory. Additionally, in the special exemplary embodiment involving trained dogs as autonomous agents capable of navigating unattended by a keeper, wayfinding guidance permits the dog to be guided along a desired path during assignments.

Since the present invention is intended in some exemplary embodiments as comprising an on-demand service, the agent might typically be dispatched from a home base station location to go to a first location for a first action such as loading up an object to be delivered from a first location, such as a storage depot, to a consumer at a destination location, or to pick up a consumer at the first location to transport the consumer to a second destination location. Upon completion of the assignment, the agent may then be guided back to the home base station or another base or service station in the service area or could be dispatched to move to a new location to begin a new assignment or might even be instructed to remain parked until further notification.

As examples of types of service that might include on-call or on-demand drone service waiting to receive a service request from a first consumer to pick up an object owned by the first consumer to be delivered to a second location, such as, for example, a customer who wishes to view the object and/or to take possession of the object as having been purchased. In another exemplary embodiment, the agent could be self-driving vehicle and the on-demand service is to dispatch the self-driving car from a first location such as the home base station location to a second location to pick up an object to be delivered to a consumer at a third location, or to take a consumer from the second location to the third location.

Another possible service type might be self-driving vehicles providing first responder service and that are small enough to maneuver between lanes of congested traffic to arrive more quickly at an emergency location with emergency equipment and possibly at least one human first responder on board. Airborne drones could also be used for quickly arriving to an emergency scene. Such first responder service might be operated by police or fire departments, ambulance services, or hospitals being service providers, with as self-driving vehicles being designed small enough to move during emergency calls between traffic lanes in congested traffic, in order to arrive more quickly at an emergency site such as an accident.

Because the present invention addresses agents of various possible forms and various different business models for types of on-call or on-demand services, there would also be variations in where and how the agents are kept between assignments. For example, one model might use a home base station in a central location of an intended service area, with the agents being guided back to the home base station between assignments, permitting the agents to be refueled and/or serviced for a next assignment. This model might be useful if the service involves, for example, delivery of products from a storage depot located in the service area or a service using trained dogs as the autonomous agents, for various types of services.

Another model might distribute agents through out a service area, possibly at predetermined service/fueling stations, so that an agent is guided to the nearest service/fueling station upon completion of an assignment. In some embodiments, the agents could be electric vehicles, so that the fueling station would be an electric charging station, and the agents could be guided to a charging station and be configured to connect up to the charging port without assistance of an operator or service attendant.

In other exemplary embodiments, an agent might be parked at or near the destination of its latest assignment, to await its next assignment, possibly then being guided back to a central location at the end of a service period such as, for example, at night, for refueling and/or service. In such embodiments, the service provider would typically want to select the nearest available agent to a new assignment request that also has the fuel available to fulfill the assignment.

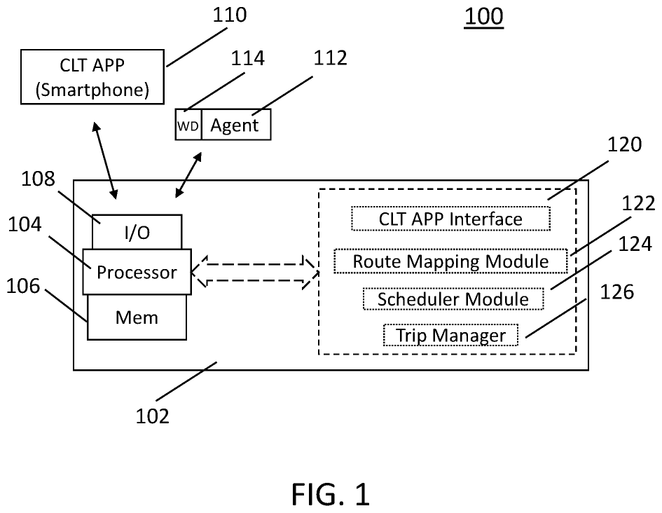

FIG. 1 shows an exemplary block diagram of an exemplary embodiment providing an exemplary on-call service using agents capable of moving autonomously using wayfinding instructions. In this exemplary embodiment, it is assumed that a user makes a service request for a service in which the assigned agent will meet up with the user as part of the service, and the user and agent will then proceed together to the destination.

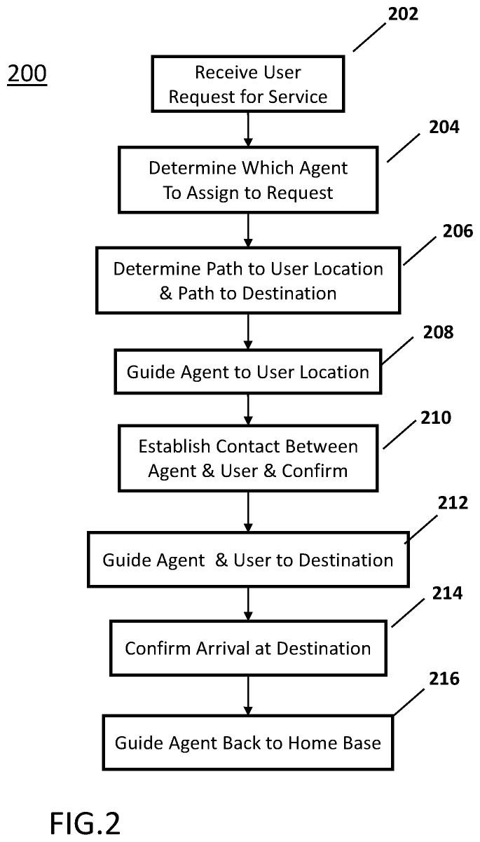

In this non-limiting exemplary embodiment, the system 100 includes a computer 102 that includes at least one processor 104 as configured to execute a program stored in a memory 106 that defines steps of the present invention as described herein and demonstrated exemplarily in FIG. 2. The software modules implementing these steps are shown in the dashed lines in FIG. 1. It is noted that the flowchart of FIG. 2 is also for only one specific exemplary embodiment, and one of ordinary skill in the art would realize that these steps are non-limiting since other service types or business models might use different steps

In this exemplary embodiment, the invention combines functionality from at least the following basic components: a client application interface module 120; a route mapper module 122; a scheduler module 124; and a trip manager 126. The computer 102 would also including devices such as a keyboard and display device, which are not shown in FIG. 1, which permit an operator of the system to control operation of the software modules and to monitor activities in the system such as checking on progress of assignments and detecting any unforeseen problems.

The computer 102 could be located at the home base station where on-call autonomous agents might be stationed to await assignments, or the computer could be located remotely from the home base station, as accessible through the Internet. In such embodiments involving a remote server, the base station might have a desktop computer used by the operator of the service for accessing the server, or the operator might interface with the server using an app on a smartphone. The computer-based method could also be implemented as a cloud service.

Additional components of the system 100 include a client app 110 as might be installed in a user's smartphone or other user mobile device or fixed station located in a service area, and a wayfinding device 114 mounted on or carried by or affixed to an agent 112 assigned to a service request originating from the user app 110. Both the client app 110 and wayfinding device 114 communicate with computer 102 via appropriate I/O ports, including, for example, ports for network interface such as Internet and/or cellular phone service or other type of transceiver appropriate for the specific type of service environment. The app for a user to make a service request might also be available at fixed points, such as kiosks or other fixed stations, located throughout the intended service area. Alternatively, an exemplary embodiment would permit a user to call a number to be connected to an app that permits the caller to make a request.

The Client Application Interface 120 receives a request from a user making a service request involving one or more destinations, the request originating from the client app 110 on a smartphone or other mobile device. Alternatively, if the user does not have a mobile device, scheduler may take requests via means such as a landline, a voice response unit input, or from kiosks or stations located at fixed locations in a service area. When an assignment trip has begun or the assigned agent is a predetermined distance from the meeting place, the client application 110 can initiate communicating the location of the device of the person(s) to be met, provided the device is equipped with a mechanism such as global positioning system (GPS) to report location. This capability can establish that the person to be met is at or near the intended initial meeting place.

The Wayfinding Device WD 114 can be any wayfinding device, depending upon the type of agent being used by the on-call/on-demand service provider, that permits the agent to receive wayfinding guidance commands and to be tracked and/or monitored. Therefore, the wayfinding device 114 would include a receiver/transmitter (R/T) unit for communications. Depending upon the type of service for which agent has been assigned, a typical basic configuration of a wayfinding device might include, for example, a GPS interface that provides current location of the agent, an accelerometer to detect motion such as might be a useful input into detecting that the agent is stalled during an assignment and needs updated wayfinding instructions, and a user input device (e.g., a keyboard) and/or a display screen or text-to-speech unit and associated speaker, for interacting with a user who has phoned in a service request, to permit the user to indicate that the agent has arrived and is ready to proceed with implementing the requested service.

In specific assignment applications, the wayfinding device 114 could include additional devices such as a camera, microphone, speaker, a pouch or storage compartment or storage platform to carry documents or other items, or a recording device should it be necessary to document events during assignments. For example, if the service involves surveillance or requires documentation or visual monitoring of the route being taken, the device might include also a camera and/or microphone and/or speaker, such that data could then be transmitted to an operator and/or a recorder at the home base station. If the service requested is intended as providing or including delivery of documents or other items, then a carrier container or pouch to carry the delivery item to its intended destination could also be mounted on the agent.

Conveying wayfinding instructions to the agent via the wayfinding device would depend upon design details of the agents being used in the on-call service. In some cases, wayfinding instructions could be an electronic signal that is interfaced with the directional control system of the autonomous agent. If the service provided involves that the user requesting the service be involved in implementing the wayfinding instructions, as might be appropriate for a service that transports the user from one location to another using a self-driving vehicle, then the wayfinding instructions could be delivered to the user/consumer using a speaker mounted in the passenger compartment of the self-driving vehicle, and the user/consumer would then interact with controls that control direction of the vehicle through a menu or push buttons correlated to different possible wayfinding instructions.

If the agent is a service animal such as a dog trained to navigate in urban environments and to respond to wayfinding instructions, then the wayfinding instructions could be given to the service animal via a collar or harness worn by the animal using either audible sounds, possibly outside the human hearing range so that the wayfinding commands are inaudible to a human involved with a service request, or via haptic transducers such piezoelectric transducers or buzzers located on different locations on the collar/harness, to provide tactile signals to the animal as wayfinding instructions. In the example of using service animals as agents, an accelerator and gravity sensor could be used to detect that the animal is sitting still for a predetermined time, as an indication that the intended path is impeded and different wayfinding instructions are expected in order to continue the assignment.

The Route Mapping Module 122 establishes routings and calculates expected travel times of the agent from the home base station to the location of the user making the request and of the agent from the meeting location to one or more destinations. Expected travel times from the home base station to the intended rendezvous point to meet with a service requester and from the rendezvous point to the intended destination can be calculated based on historical data for each agent and each type of agent and type of route segments. Thus, given that the system calculates expected travel times for the intended path, another method to determine whether an agent has become stalled along the intended path would be to calculate expected travel times along individual path segments and then conclude an agent has reached an impediment if a path segment takes a predetermined length of time beyond the time calculated for that segment.

Various possible service types might be intentionally confined to an area or an urban environment surrounding a home base station which is intentionally limited in size, and the service area might have a limited number of possible paths that an agent can follow. For example, self-driving vehicles used in an urban area would be inherently constrained to use existing roadways, and a drone delivery service might be constrained to operate using paths between tall buildings or paths that avoid specific areas such as airports or areas expected to have a high density of persons, such as a sports stadium expected to be hosting an event.

Therefore, one method to determine mapping for any service request in such service areas with a limited number of possible paths would be to maintain a database of all possible route segments for that service area and areas or possible route segments to avoid. Thus, in an urban environment, possible route segments might comprise city block units in the service area. With each possible route segment, a matrix of characteristics could be defined, including such characteristics as potential traffic congestion at certain times of the day, safety concerns such as steep slopes that might dangerous during snow or rain, etc. This database could be derived from map data of the service area with annotations manually inserted for characteristics such as weather safety concerns that might not be included in conventional map data.

In the embodiments involving a service dog as agent and given that the service being provided might include that a user requesting service would accompany the dog during the assignment, the characteristics of each path segment might include such factors as lighting, known safety hazards, areas considered to be dangerous, time of day of the assignment, and age and gender of the user requesting service. For example, if the service being provided involved accompanying a person requesting service from one location to a destination location, then the routing that is calculated by the route mapping module might consider only possible route segments that are well lit and would avoid route segments considered as possibly dangerous.

In establishing a routing for a specific service request, the system would then construct a combination of route segments from the database that have the desired endpoints and that have the desired characteristics such as safety, etc., and which is the shortest combination that could be established for the desired endpoints.

As an alternative to maintaining a database of predefined possible route segments for the service area, routing information for a specific service request could be derived by storing the raw map data of the service area in a database, with annotations for characteristics such as safety being entered generally for different areas of the service area.

In establishing a routing for a specific service request, the system would look through the raw map data for possible paths for travelling between the desired points and select those paths having the characteristics considered desirable for each service request.

Since there may be more than one base station located in any local urban environment and service areas might overlap, the present invention includes an embodiment in which possible route segments are available to different home base stations in the system, and any service request might take an assigned agent outside the urban environment typically serviced by its own specific base station and, accordingly, an agent in such multi-station urban environment service areas might be dispatched from one base station and instructed to go to another base station upon completion of its current assignment.

The routing that is determined for each service request could depend upon the specific type of service(s) being provided from that specific base station, the specific locations of the user making the request and of the desired destination. The routing determined for a service request could be affected by such factors as time of day, weather, age and/or gender or other characteristics of a person involved with the service request, requests by the user as might be, for example, options available when making a request.

Thus, in the context of the present invention, the term “waypoint” can also be understood as referring to endpoints or intersections of possible predefined route segments in a local environment serviced by a home base station, and wayfinding instructions can be broadly interpreted as pivot points along the intended route.

The term “wayfinding” is intended herein as referring to guidance provided to agents such as, for example, left/right/forward/reverse, the wayfinding signals providing directional information that guide an assigned agent along the routing determined to implement an assignment in response to a service request by a user. The wayfinding signals would typically be provided to the assigned agent during an assignment at waypoints along the determined route for the assignment, the waypoints being either endpoints or intersections of a combination of route segments in the urban environment served by the home base station.

The Scheduler Module 124 receives input from the route mapping module 122 and establishes timing of the assigned agent. The scheduler 124 also selects the specific agent for an assignment based on rules or weighting of factors such as number of trips, probable timing of trips, total distance, current location of agents, etc. Scheduler module 124 may mark agents as available or not available depending on these factors. It should be clear that specific factors for selecting a specific agent for an assignment can vary with different types of service being provided. The scheduler 124 also indicates if the agent is available for a next trip and if it should return to home base, go to a pick-up location in which the agent picked up to be transported to a base station, go to a next meeting location, return to a different base station in the system if there are multiple base stations in the service area, or possibly be instructed to park somewhere to await another assignment.

The Trip Manager 126 determines if the person making a request is at the location, assuming the person has a device that is communicating location, and/or that the assigned agent is at the meeting location at the scheduled time. In some embodiments, the trip manager could provide indication of the current location of the assigned agent on the client app 110 of the person making the request, so that the requestor is aware of the agent's location and expected arrival time. If the user has a device with the client app 110, the app might send a confirmation that the person and assigned agent have met, based on a selection made by the user via the app 110. Alternatively, based on a user selection on their smartphone app, the client application 110 communicates that they have not yet met, and the trip manager 126 communicates location of the assigned agent that is travelling toward the person's location, based on the GPS location reported by the user's smartphone. If the user and assigned agent cannot find each other, optionally, the trip manager 126 may send a signal for the agent to perform an action, such as emitting a sound such as honking a given number of times for self-driving vehicles used as agents. If the person making the request has no device or it is not communicating, a user input device could be incorporated on the agent, to accept a coded entry from the person to be met, confirming that they are the right person and permitting the service portion to commence.

Upon a successful meeting between the user requesting a service and the assigned agent, the trip manager 126 initiates a signal to the agent to start, and sequentially provides wayfinding commands indicating directions to proceed along the precalculated route based on the agent's current location. The assigned agent can be tracked via a GPS receiver/transmitter unit embedded in the wayfinding device carried by the agent. For example, in an exemplary embodiment, the trip manager 126 combines GPS, accelerometer, and compass data (e.g., gyro) to determine the agent's progress and can re-route the planned routing if necessary. For example, if the agent remains stationary for a predetermined period of time, the system presumes that an obstruction has been encountered so that the agent cannot proceed on the mapped path in a desired timely manner, thus triggering a potential re-routing to complete the assignment. The trip manager 126 may distinguish an obstruction event from events, such as waiting for stop lights by using data from an accelerometer and gyroscope to determine timing periods during which the agent is stationary.

Trip manager 126 confirms the assigned agent's arrival at the planned destination. On a user selection, the client application 110 sends a confirmation from the requesting user that the assigned agent and person to be served have met. The trip manager module 126 initiates navigation to the first destination and proceeds according to data from the route mapping module 122 and monitored via GPS data, with directions and commands communicated to the agent via the wayfinding device as described above, again using wayfinding guidance directions.

The GPS unit on the wayfinding device sends data to enable the trip manager 126 to confirm arrival at the destination. If the user has a device and accompanies the assigned agent from the initial rendezvous meeting location to the destination location, GPS data from the client application 110 can be sent to the trip manager 126 in order to confirm arrival at destination. In an alternate exemplary embodiment, if a user has no mobile device, a user input device on the wayfinding device can be used to send confirmation of arrival to the trip manager 126. The trip manager 126 can also be configured to send confirmation of arrival to a display screen or text-to-speech unit on the wayfinding device. Upon arrival at the destination, the trip manager 126 can then initiate a return to home base, a pick up location, or a next meeting location via instructions communicated through the wayfinding device. The agent is then guided to that location as described above.

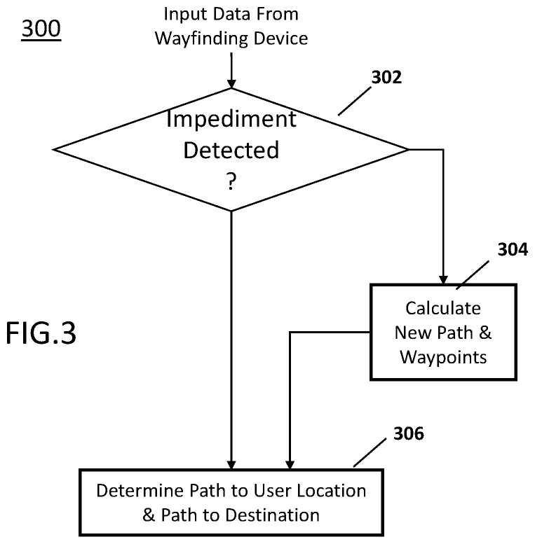

In some exemplary embodiments, the trip manager 126 additionally includes a path impediment detection module that determines whether to calculate an alternate path in an event that an agent on assignment encounters an impediment along the originally-planned path, as further described in FIG. 3. Should a path impediment be detected, the trip manager 126 will provide an input into the route planning module 122 to request that an alternate path be calculated, so that the path is updated and new wayfinding instructions sent out accordingly which are intended as working around the impediment.

FIG. 2 shows exemplarily in basic flowchart format 200 a non-limiting example of a method of an exemplary embodiment of the present invention involving an application in which agents are configured to autonomously navigate unattended, to meet up with a user requesting service and the agent and user proceed to the destination location. In other types of service such as delivering a document or simple surveillance either between the initial rendezvous point and the destination point or at the destination point itself, the person making the service request may not even accompany the agent to the destination point. Thus, the present invention is directed to any type of service that can be implemented by guiding an agent unattended, using wayfinding signals to which an assigned agent recognizes and responds to during the execution of the service. The service may involve meeting up with a user requesting service, at a specified first meetup location, and then providing the selected assigned agent to a second location by also using wayfinding guidance signals received using a wayfinding device mounted on an agent assigned to a service request.

The wayfinding guidance signals are provided from, for example, a computer and transmission mechanism located at the home base station. This transmission and reception mechanisms used in providing the wayfinding signals to the assigned agent could involve one or more mechanisms and devices that are often referred to as categories of IoT (Internet of Things), either or both in the manner of transmitting signals from the home base station and in the wayfinding device on the wayfinding device used to receive these signals and convey them to the agent during the assignment.

In step 202 of this exemplary embodiment a request for service is received. Because the exemplary embodiment being described involves a base station that dispatches a selected agent for an assignment, the service area involved would typically be at least somewhat localized around that base station. In step 204, if multiple agents are available at the home base station, a determination process is invoked to select a specific agent to be assigned for a received request. Various factors could be involved in determining which possible agent would be best for a specific assignment. For example, an agent that has recently returned from an assignment could be less selectable by reason of requiring maintenance compared to another available agent.

In step 206 a computer determines a route as originating from the base station to the current location of the user making a service request, using map data or a database of possible route segments for the service area. In many exemplary embodiments, the routing for assignments comprises more than determining the shortest distance between two points in the service area. Rather, determining an assignment routing comprises determining a combination of predetermined route segments that are stored in a database for that local urban environment of each home base station. The determined combination includes the desired endpoints in the service area for the specific user's request for service.

In step 208, the assigned agent is dispatched from the home base with a wayfinding device and guided to the user's location using wayfinding commands from the wayfinding device, as transmitted based on the current location of the agent.

In step 210, communication with the user requesting service and the assigned agent occurs and the meetup is confirmed. Various meetup/confirmation mechanisms are possible. For example, the user might press a button on a kiosk station or on a smartphone app that sends a signal back to the home base station that the assigned agent has arrived at the requested meeting place so that the assigned service can now commence. In some embodiments, the agent could emit an audible signal a predetermined number of times upon approaching the scheduled meeting place, particularly if the person requesting the service does not see or does not recognize the assigned agent approaching the intended rendezvous location. In other embodiments, the wayfinding device could include a button or a keyboard permitting the requestor to enter a code designed for that specific assignment to indicate that the assigned agent has arrived, so that the intended service can now commence.

In step 212, the assigned agent is then guided, again using wayfinding commands, to the predetermined destination location. If necessary due to unforeseen events along the route to the destination or due to predefined motions of the agent as detected by sensors on the wayfinding device, changes can be made to the originally-planned routing.

In step 214, confirmation is received of arrival at the destination, so the assigned agent can then be released from the assignment. Again, various mechanisms could be used to signal that the assigned service has been accomplished, including, for example, the exemplary embodiments in which someone at the destination indicates via a button or keyboard on the wayfinding device or on a mobile app that the destination has been reached, so that the assignment has been completed.

In step 216, the assigned agent could then be guided back to the home base for availability of a new assignment, again using wayfinding commands determined, for example, by the computer at the home station or on a server accessible via a network. Of course, rather than returning to home base immediately, the assigned agent could be guided to a new assignment location for another request, particularly if the destination is near a location for a new user request or a new user request is received while the assigned agent is returning to home base, or an agent completing an assignment could possibly be directed to await pickup by a van that will pick up the agent and return it to the home base station.

FIG. 3 shows in flowchart format 300 the recalculating of the path used for generating the wayfinding instructions sent to an agent once it has been dispatched on an assignment. This subroutine could be implemented anywhere during an assignment. Thus, in the exemplary flowchart shown in FIG. 2, the recalculating of the intended path to be followed by the assigned agent could occur anywhere between steps 208-216. The steps shown in FIG. 3 could be incorporated into the trip manager module 126 shown in FIG. 1, or could be incorporated into an independent module that interfaces with the remaining modules as appropriate.

As shown in FIG. 3, in an exemplary embodiment an input port is monitored in step 302 for presence of a signal indicating that the wayfinding device has detected that its autonomous agent has encountered an impediment. Since the trip manager 126 is aware of the current location of the agent, the trip manager can now instruct the route planning module 122 to plan, in step 304, a new route from that current location to arrive at the intended destination location to complete the assignment. The wayfinding guidance instructions will then continue to be transmitted in step 306.

The technique of detecting whether the autonomous agent has encountered an impediment requiring a re-routing of the path to be followed by the agent can vary. For example, as previously mentioned, a self-driving vehicle could incorporate cameras which permit detection of a path impediment by an analysis using either a computer on the wayfinding device 114 in or on the autonomous agent. Data from the camera(s) could also transmitted from the wayfinding device to a remote computer, for remote evaluation of the image data. The image data need not be continuously analyzed since it could be analyzed whenever the autonomous agenda is detected as having stopped for a predetermined period of time. In some exemplary embodiments, an accelerometer would provide acceleration data, and in an exemplary embodiment using dogs as the autonomous agent, an accelerator in combination with a gravity sensor detects that the dog is sitting, as the dog has been trained during its initial training to sit in a predetermined sitting position when it detects that its path has been impeded. In yet another exemplary embodiment, the trip manager could receive the agent's current location and the trip manager could itself detect a suspicion of a path impediment by calculating which segments are taking too long to finish a current route segment.

System Implementation

The present invention can be implemented in a number of various computer implementations, including a cloud service as offering a specific service such as an on-call service via the cloud. Of course, the service could also be provided using a desktop computer or server on the Internet. Therefore, although this disclosure includes a detailed description on cloud computing, as follows, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

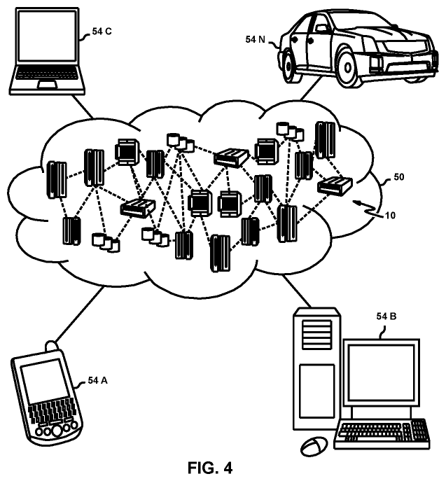

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

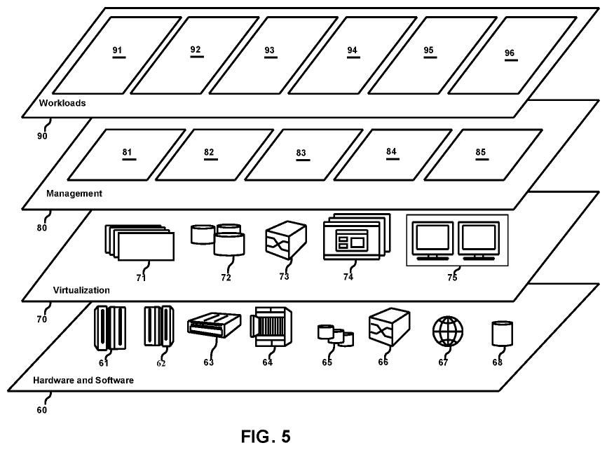

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include tasks related to the implementation of the present invention in which an on-call service is available as a cloud service.

Service Models Using Trained Service Dogs

Since there are various types of possible autonomous agents that could be used in the context of the present invention, it should be clear that each type or category of autonomous agents has unique characteristics.

For example, when the autonomous agents are service dogs trained to navigate the environment of the service are of a home base station and trained to respond to wayfinding instructions received from a remotely-located computer, the wayfinding device would typically be mounted or attached to a harness/collar/jacket/pullover covering/etc. Typically, for service involving a trained service dog responsive to wayfinding instructions, the service area would be an urban environment and would be limited in size because an assignment would involve a selected dog walking a path within the service area. In addition to being trained for responding to wayfinding instructions, these dogs would have been pretrained to navigate traffic expected to be encountered in an urban environment, including aspects such as recognizing and coping with traffic lights and urban traffic, ignoring people encountered on an assignment (other than the user making the service request), and travelling only along predetermined paths such as sidewalks and other walkways.

Additionally, a dog could be trained to bark a predetermined number of times upon receiving a specific wayfinding instruction, as might be useful to permit the dog to be recognized by a user making a request for service and to make it easier for the assigned dog to meet up with the user.

Typical services that use trained dogs would involve services in which the dog is either used to transport a small object such as documents, as inserted into a carrier pouch on the harness worn by the assigned dog by the user making a request, to a destination, or a service in which the dog becomes a guide or otherwise accompanies the user making the request to another location, such as guidance of the person to an unknown location or accompaniment in an unfamiliar or potentially unsafe environment.

For example, consider a college campus with a student studying late at night needing then to return to their dormitory or apartment. Or consider a new resident in an unfamiliar urban environment who wants to be guided to a specific location where they have never been and is unfamiliar with that location or how to get there. Other non-limiting examples of the service need being filled by using trained dogs as described in the present invention might include, for example, a student being accompanied as they walk to or from school, or the student being walked to and from a doctor's appointment during the school day. Additionally, a trained service dog could be dispatched for an assignment in which it provides companionship to a user requesting service, such as companionship for residents at a residence for older persons or companionship or guarding of children in a playground, park, or school. Other potential services that trained dogs might be used include, for example, providing surveillance or assignments to guard against intruders or for detecting potential dangerous or illegal activity such as sniffing for explosives or drugs.

Because of the many possible services that a service dog could potentially be trained to implement during assignments, the wayfinding device worn during an assignment might vary considerably. For example, it might comprise any wearable item that can be worn by an assigned working dog at least during time that the dog has been dispatched on an assignment, in order for the service dog to receive wayfinding guidance commands and to be tracked and monitored. Thus, wayfinding device 114 (FIG. 1) might be a collar or a harness or a jacket or a pullover covering or other type of wearable item. Depending upon the type of service for which the dog has been assigned, a typical basic configuration of a collar or harness or jacket or other wearable device might include, for example, a GPS interface that provides current location of the dog, an accelerometer, a gravity sensor and/or gyroscope, a buzzer, speaker, or other device to communicate directions and commands to the dog, a user input device (e.g., a keyboard), and/or a display screen or text-to-speech unit and associated speaker (for example, to permit the person making a service request to indicate that the assigned dog has arrived at the user's location and met up with the intended user making the request).

Because a dog can hear frequencies outside the human hearing range, the wayfinding instructions could be emitted in a frequency that the dog can hear but would be inaudible to any humans in the area. Additionally, the wayfinding device 114 could include transducers mounted at different locations on the collar or harness, etc. by which tactile stimulations or a pattern of tactile stimulations would be interpreted by the dog as corresponding to the different possible wayfinding instructions.

The accelerometer can be used to detect whether the dog has assumed a position such as sitting for at least a predetermined amount of time, as a predetermined position signaling that the dog's path is blocked and the dog is awaiting further instruction. The gravity sensor can be used to sense the orientation of a collar should such orientation be needed to distinguish left/right orientation as the collar is currently fastened on the dog.

In specific assignment applications, the wearable device could include additional devices such as a camera, microphone, speaker, a pouch to carry documents or other items, or a recording device should it be necessary to document events during assignments. For example, if the service involves surveillance or requires documentation or visual monitoring of the route being taken, the harness might include also a camera and/or microphone and/or speaker, which could then be transmitted to an operator and/or a recorder at the home base station. If the service requested is intended as providing or including delivery of documents or other small items, then the harness/collar could also include a pouch to carry the delivery item to its intended destination.

In another possible variation, a harness could include a computer that permits a preassigned route to be calculated and followed, without receiving guidance instructions from a home base station. In this variation, the computer receives sensor inputs, such as GPS data, to determine current location and provides guidance instructions without inputs from the home base station, returning to the base station upon completion of the assignment. However, such embodiment would preclude the capability of being able to change the intended route should the dog encounter an impediment.

In yet another variation of possible service, an agent could be dispatched to a predetermined location and given a specific signal indicating that the assignment is to patrol or protect this assigned location from intruders. In such types of assignments, the harness or collar could include a camera and/or microphone or speaker, to permit the service operator to remotely monitor events at the protected location. \

In another variation, a specific signal would be provided to tell the assigned dog to terminate or interrupt the assignment and await for wayfinding instructions to return to home base, for whatever reason including, for example, that a user cancels the service request before the assigned agent arrives at the intended location to initially meet the user.

Thus, it should be clear that the on-call service of the present invention can be directed to any specific type of service for which a service agent can be trained, further in view of training that allows the service dog to navigate unattended in a service area, as including, for example, training for dealing with street and road traffic, traffic lights and signs, training to either ignore people routinely encountered during assignments or to become aggressive under certain situations encountered during an on-call assignment, and any other training appropriate to navigating urban environments with a given service to perform even if that service is achieved by reason of merely walking along sidewalks and walkways in response to wayfinding instructions. It should also be clear that any specific service dog could be trained for various different services or different types of services.

Additionally, relative to using trained service dogs as an autonomous agent, expected travel times from the base station to the intended rendezvous point to meet with a service requester and from the rendezvous point to the intended destination can be calculated based on historical data for each service dog, in view of such metrics as tiredness, time of day, etc.

Also, using trained service dogs would typically involve a service area that is an urban environment, and a service area for any specific base station would be limited in size because dogs are used to implement service requests, as walking between potential destinations within the service area. Therefore, one method to determine mapping for any service request in the service area would be to maintain a database of all possible route segments as predetermined for each home base station over which a service dog would reasonably be expected to walk unattended, such as route segments comprising sidewalks, bridge walkways and foot bridges over roads, crosswalks at intersections, etc.

Thus, these route segments would not be arbitrary and would not typically be direct routes between the two desired endpoints of an assignment, since the route segments would have to be paths, such as sidewalks or other walkways whether straight or curving, over which a dog would be able to walk unaccompanied by a supervisor or trainer in view of training to navigate urban realities such as traffic including both vehicular and passersby traffic. The route segments would also be paths over which a service dog would be expected to continue walking in a forward direction as initially trained, whether straight or curving, once travel on that path has been started, until another instruction instructs the service dog to change direction or stop. With each possible route segment, a matrix of characteristics would be defined, including such characteristics as visibility, amount of light after dark, safety concerns, etc. This database could be derived from map data of the service area with annotations manually inserted for characteristics such as safety and lighting that might not be including in conventional map data.

In establishing a routing for a specific service request, the system would then construct a combination of route segments from the database that have the desired endpoints and that have the desired characteristics such as lighting, safety, etc., and which is the shortest combination that could be established for the desired endpoints.

As an alternative to maintaining a database of predefined possible route segments for the service area, routing information for a specific service request could be derived by storing the raw map data of the service area in a database, with annotations for characteristics such as lighting and safety being entered generally for different areas of the service area.

In establishing a routing for a specific service request, the system would look through the raw map data for possible paths for foot traffic between the desired points and select those paths having the characteristics considered desirable for each service request.

Since there may be more than one base station located in any local urban environment and service areas might overlap, the present invention includes an embodiment in which possible route segments are available to different home base stations in the system, and any service request might take an assigned dog outside the urban environment typically serviced by its own specific base station and, accordingly, a service dog in such multi-station urban environment service areas might be dispatched from one base station and instructed to go to another base station upon completion of its current assignment.

The routing that is determined for each service request could depend upon the specific type of service(s) being provided from that specific base station, the specific locations of the user making the request and of the desired destination. The routing determined for a service request could be affected by such factors as time of day, weather, age and/or gender or other characteristics of a person involved with the service request, requests by the user as might be, for example, options available when making a request.

For example, a service that provides a dog to accompany a person back to a college dormitory, local apartment, or sorority or frat house might have route segments that involve only segments along public, well-travelled paths that are also well-lit and/or very visible. Another service might involve route segments having security cameras or security lights strategically mounted along one or more of the route segments, and the present invention includes an exemplary embodiment in which these cameras or lights can be selectively activated during an assignment as the selected dog traverses various route segments. In other urban environments, only route segments known to avoid known hazards or possible known dangers would be available in the route segment database associated with that home base station.

Having such limited number of pre-planned possible route segments also permits each trained dog at that home base station to be familiar with potential routes in that local urban environment, thereby possibly permitting easier training. Additionally, a limited number of possible route segments also permits these possible route segments or intersections of segments to be locations known to the dogs as possible pivot points (waypoints) during assignments.

Thus, in this respect, the term “waypoint” can refer to endpoints or intersections of possible predefined route segments in a service area or to locations where another wayfinding instruction would be transmitted to a dog on assignment, including locations for the instruction “proceed straight ahead”, since it could be important to provide repetitious signals periodically to a dog in order to keep the dog's attention.

Of course, it should be apparent that additional waypoints other than the originally-planned routing waypoint commands might be necessary should current position tracking of the assigned dog determine that the assigned dog has strayed or deviated from the originally-planned routing or has stopped along the originally-planned routing because of some unforeseen problem. Such unintended deviations from the intended routing of an assignment would also cause an alert at the home base station so that appropriate monitoring and possible remedial action could be taken be the operators at the home base station.

The selection of which possible working dog is to be assigned to a specific service request would be based on rules or weighting of factors such as number of trips, probable timing of trips, total distance, feeding times, etc., and dogs could be marked as available or not available depending on these factors. The scheduler 124 (FIG. 1) also determines if the dog is available for a next trip and if it should return to home base, go to a pick-up location, go to a next meeting location, or possibly even return to a different base station in the system if multiple base stations serve an urban environment, or even wait for a van to pick up the dog.

It should be clear that specific factors for selecting a specific dog for an assignment can vary with different types of service being provided. For example, using the exemplary service of providing guidance back to a dormitory on a college campus, the time of day might be a factor, as well as the location of the meeting place and destination. In some cases, the dog might be selected based on additional specialized training and ability to potentially bark or provide other aggressive behavior should the assignment be deemed to involve protection during the assignment as well as guidance to the destination. Such selection might be based on characteristics of the meeting location, the destination location, and possible routes between the meeting location and destination.

In other specific requests, the requestor might have made a request for a specific dog based on previous service requests. In other requests or services, a dog with a friendly personality might be preferred. Other non-limiting characteristics, such as age or gender of the person making a request, as selectively entered by a user when making a service request, might be factors involved in making a selection of a dog to implement a service request, as well as the simple determination of which dogs are currently available at the home base station for servicing a request. In some embodiments, a user might be able to request to wait for service until a specific dog or type of dog becomes available, and the system will be able to calculate an expected wait time based on current activity at the home base station.

If the on-call dogs of the exemplary embodiment are intended for a guiding or accompaniment service, some dogs may also be trained to provide protection as necessary for the type of service anticipated for each specific urban environment. For example, some dogs might be trained to bark or act aggressively and/or even to defend against a potential attacker upon command of the customer being accompanied or remotely by an agent of the service or even sua sponte based on specific training permitting the dog to recognize and respond to threats during an assignment. However, in another type of service such as providing companionship to senior citizens, a small, friendly type of dog might be preferred as the selected service dog for that assignment.

Additional aspects that can be included in the working dog on-call provisioning method of the present invention could include such features as:

dog preferences/selector, providing clients choices of which dog to choose or what size/breed of dog to choose, if available.

dog profile with swipe, providing clients the capability to skip dogs not selected in the past.

dog shuttle to pick up the dogs, a “woofer van” being a vehicle that can track locations of dogs to be picked up for transport from their current location, perhaps back to home base or an alternate service area such as a large public event.

dog rating system providing a “Net Promoter Score” or “Recommender” for specific dogs, as a system to collect and provide feedback on dogs and their behavior on assignments.

Relative to service requests in which the assigned dog is to meet up with the user making the request, the trip manager 126 (FIG. 1) determines if the person to be met is at the location, assuming the person has a device that is communicating location, and/or that the assigned dog is at the meeting location at the scheduled time. In some embodiments, the trip manager could provide indication of the current location of the assigned service dog on the client app 110 of the person making the request, so that the requestor is aware of the service dog's location and expected arrival time. If the user has a device with the client app 110, the app might send a confirmation that the person and assigned dog have met, based on a selection made by the user via the app 110.

Alternatively, based on a user selection on their smartphone app, the client application 110 communicates that they have not yet met, and the trip manager 126 communicates location of the assigned service dog that is travelling toward the person's location, based on the GPS location reported by the user's smartphone. If the user and assigned dog cannot find each other, optionally, the trip manager 126 may send a signal for the dog to perform an action, such as barking a given number of times. If person has no device or it is not communicating, a user input device could be incorporated on the dog collar/harness, to accept a coded entry from the person to be met, confirming that they are the right person and permitting the service portion to commence.

Upon a successful meeting between the user requesting a service and the assigned dog, the trip manager 126 initiates a signal to the dog to start, with a sequence of wayfinding commands indicating directions to proceed along the precalculated route. The assigned dog has been trained to comply with wayfinding commands received and the assigned dog can be tracked via a GPS receiver/transmitter unit embedded in the collar. In this exemplary embodiment, the trip manager 126 combines GPS, accelerometer, and compass data to determine dog progress and can re-route the planned routing if necessary. For example, if the dog is trained to sit as indicating that an obstruction has been encountered, the gyro and accelerometer data will be interpreted as detecting that the dog has encountered an obstruction and cannot proceed on the mapped path, thus triggering a potential re-route. The trip manager 126 may distinguish an obstruction event from events such as a dog waiting for a stop lights by using the accelerometer and gyroscope inputs to determine if the dog remains standing and is ready to proceed, or is sitting.

Trip manager 126 confirms the assigned dog's arrival at the planned destination. On a user selection, the client application 110 sends a confirmation from the requesting user that the assigned dog and person to be served have met. The trip manager module 126 initiates navigation to the first destination and proceeds according to data from the route mapping module 122 and monitored via GPS data, with directions and commands communicated to dog via the collar as described above, again using wayfinding guidance directions.

The GPS unit on the dog's collar sends data to enable the trip manager 126 to confirm arrival at destination. If the user has a device and accompanies the assigned service dog from the initial rendezvous meeting location to the destination location, GPS data from the client application 110 can be sent to the trip manager 126 in order to confirm arrival at destination. In an alternate exemplary embodiment, if a user has no mobile device, a user input device on the dog collar can be used to send confirmation of arrival to the trip manager 126. The trip manager 126 can also be configured to send confirmation of arrival to a display screen or text-to-speech unit on the dog collar. Upon arrival at the destination, the trip manager 126 can then initiate a return to home base, a pick up location, or a next meeting location via instructions communicated through dog collar. The dog is then guided to that location as described above.

Finally, it is noted that other types of service animals other than dogs can pretrained to respond to wayfinding instructions and be dispatched on an assignment and then be guided by wayfinding instructions transmitted from a home base station. For example, animals capable of conducting underwater assignments have already been demonstrated in various applications, and such animals could be outfitted to accommodate the methods of the present invention.

The descriptions of the various embodiments of the present invention have been presented for purposes of illustration, but are not intended to be exhaustive or limited to the embodiments disclosed. Many other modifications and variations will be apparent to those of ordinary skill in the art without departing from the scope and spirit of the described embodiments. Thus, it should be clear that the configuration of FIG. 1 and the flowchart in FIG. 2 are not to be considered as limitations on possible components and methods of the present invention. It is also noted that the terminology used herein was chosen to best explain the principles of the embodiments, the practical application or technical improvement over technologies found in the marketplace, or to enable others of ordinary skill in the art to understand the embodiments disclosed herein.

While the invention has been described in terms of several exemplary embodiments, those skilled in the art will recognize that the invention can be practiced with modification. Further, it is noted that, Applicants' intent is to encompass equivalents of all claim elements, even if amended later during prosecution.

What is claimed is:

1. A system, comprising:
a processor; and
a memory device accessible to the processor, the memory device storing a set of machine-readable instructions to permit the processor to execute a method for providing a service using agents capable of autonomously navigating unattended within a service area, as guided along a predetermined path based on receiving wayfinding instructions,
wherein the processor comprises a communication port to permit a communication during assignments with one or more communication devices on a wayfinding device carried by or attached to an agent selected for implementing an assignment, and
wherein the method comprises:
receiving a request for the service from a user at a first location for the service to start as originating at the first location and to end at a destination at a second location;
mapping a routing between a current location of the agent selected to implement the service request as an assignment to the first location and a mapping between the first location and the destination at the second location; and
dispatching the agent selected for the assignment from the agent's current location to the first location, to meet up the user making the request for service, the agent being guided to the first location using wayfinding guidance instructions received via a receiver on or attached to the wayfinding device,
wherein the agent has a capability to respond to wayfinding guidance instructions received via the wayfinding device.

2. The system of claim 1, wherein the method further comprises selecting which agent from a plurality of agents will implement the service request as the assignment.

3. The system of claim 1, wherein the wayfinding device carried by or attached to the agent further comprises a location sensor that detects a current location of the agent and the wayfinding device transmits the current location to be received at the communication port of the processor.

4. The system of claim 3, wherein the location sensor comprises a global position system (GPS) sensing device.

5. The system of claim 3, wherein the method further comprises verifying that the agent has reached the first location or the second location based on comparing the current location of the agent as sensed by the location sensor with a location determined by a separate location sensor external to the wayfinding device.

6. The system of claim 1, wherein the wayfinding device carried by or attached to the agent further comprises a sensor that detects when the agent has encountered an impediment to the routing mapped out for the assignment.

7. The system of claim 6, wherein the method further comprises:
detecting when the agent has encountered the impediment to the routing mapped out for the assignment;
mapping a new routing beginning at a location of the detected impediment, for completing the assignment using the new routing; and
providing updated wayfinding instructions to the agent for the new routing.

8. The system of claim 6, wherein the wayfinding device carried by or attached to the agent includes one or more cameras and a capability of itself executing image analyses to identify obstacles or to provide additional information to be used in calculating the new routing.

9. The system of claim 6, wherein the sensor that detects when the agent has encountered an impediment comprises an accelerometer.

10. The system of claim 1, wherein the wayfinding guidance instructions are provided to the agent by haptic vibrations in a pattern predetermined to provide direction instructions to the agent.

11. The system of claim 1, wherein the wayfinding guidance instructions are provided to the agent using audible sounds emitted outside a human hearing range.

12. The system of claim 1, further comprising an app permitting a user at the first location to initiate a service request.

13. The system of claim 1, wherein the method further comprises:
verifying that the agent has reached the first location; and
verifying that the user at the first location that initiated the service request has acknowledged arrival of the agent.

14. The system of claim 1, wherein the method further comprises:
detecting that the agent has arrived at the destination second location so that the assignment is complete;
determining how the agent should proceed upon completion of the assignment; and
sending one or more wayfinding instructions to the agent based upon completing the assignment to define how the agent is to proceed upon the completion of the assignment.

15. A method to provide a service using agents capable of autonomously navigating within a service area as guided based on receiving wayfinding instructions, the method comprising:
receiving a request for the service from a user at a first location for the service to start as originating at the first location and to end at a destination at a second location;
mapping a routing between a current location of an agent selected to implement the service request to the first location and a mapping between the first location and the destination at the second location; and
dispatching the selected agent from its current location to the first location to meet up with the user making the request for service, the selected agent being guided to the first location using wayfinding guidance instructions received via a receiver on a wayfinding device mounted on or attached to the selected agent,
wherein the selected agent has a capability to respond to wayfinding guidance instructions received via the wayfinding device.

16. The method of claim 15, further comprising, upon the receiving of the request for service, selecting an agent to implement the service request as an assignment.

17. The method of claim 15, further comprising:
detecting a current location of the selected agent after being dispatched; and
providing wayfinding instructions to the selected agent via the receiver on the wayfinding device based on the current location of the selected agent.

18. The method of claim 15, further comprising detecting when the selected agent has encountered an impediment to the routing mapped out for the assignment;
mapping a new routing beginning at a location of the detected impediment, for completing the assignment using the new routing; and
providing updated wayfinding instructions to the selected agent for the new routing.

19. The method of claim 15, further comprising:
verifying that the selected agent has reached the first location;
verifying that the user at the first location that initiated the service request has acknowledged arrival of the selected agent;
detecting that the selected agent has arrived at the destination second location so that the assignment is complete;
determining how the selected agent should proceed upon completion of the assignment; and
sending one or more wayfinding instructions to the selected agent based upon completing the assignment that defines how the selected agent is to proceed following the completion of the assignment.

20. A method to provide a service using agents capable of autonomously navigating within a service area as guided based on receiving wayfinding instructions, the method comprising:
receiving a request for the service from a user;
determining a routing to be followed by an agent to be dispatched to implement the received service request; and
dispatching the agent to implement the received service request, the dispatched agent being guided along the determined routing using wayfinding guidance instructions received via a receiver on a wayfinding device mounted on or attached to the dispatched agent,
wherein the dispatched agent has a capability to respond to wayfinding guidance instructions received via the wayfinding device, and
wherein the wayfinding device carried by or attached to the dispatched agent further comprises a sensor that detects when the dispatched agent has encountered an impediment to the routing mapped out for the assignment, so that a new routing can be determined for guiding the dispatched agent to complete implementing the received service request.
